(19) United States
(12) Patent Application Publication
(10) Pub. No.: US 2005/0251418 A1
(43) Pub. Date: Nov. 10, 2005

(54) System and method for processing ad hoc orders in an automated patient care environment

(75) Inventors: Charles S. Fox JR., Leawood, KS (US); Steven Kirsch, Prairie Village, KS (US); Greg Meyer, Smithville, MO (US)

Correspondence Address: SHOOK, HARDY & BACON L.L.P., 2555 GRAND BOULEVARD, KANSAS CITY, MO, 64108-2613, US

(73) Assignee: Cerner Innovation, Inc., Overland Park, KS (US)

(21) Appl. No.: 11/025,970

(22) Filed: Jan. 3, 2005

Related U.S. Application Data
(63) Continuation-in-part of application No. 10/684,820, filed on Oct. 15, 2003.

(51) Int. Cl. G06F 17/60

(52) U.S. Cl. 705/2

(57) ABSTRACT

The present invention is directed to a method and system for managing patient care in order to minimize caregiver error and to accommodate ad hoc entry of orders. The system may be driven by machine readable identifiers. The identifiers may include bar codes. The system may include a portable computing device having an identifier recognition mechanism and a patient machine-readable identifier. The system may additionally include a patient task list for an identified patient, wherein the task list becomes automatically available upon recognition of the patient machine readable identifier. The system may also include recognition tools for determining if an entered task is a recognized task that is consistent with any task contained within the patient task list. The portable computing device may include a user interface mechanism for allowing an authorized caregiver to enter a new order including an unrecognized task. A method of the invention may include recognizing a patient machine-readable identifier, matching the patient machine-readable identifier with a patient task list, determining whether an entered task request is consistent with any task on the patient task list, and allowing entry of an order including an unrecognized task by an authorized caregiver.

### CROSS-REFERENCE TO RELATED APPLICATIONS

This application is a continuation-in-part of application Ser. No. 10/684,820 filed Oct. 15, 2003 from which application priority is thereby claimed.

### STATEMENT REGARDING FEDERALLY SPONSORED RESEARCH OR DEVELOPMENT

None.

### TECHNICAL FIELD

Embodiments of the present invention relate to management of patient care. More particularly, embodiments of the invention are directed to facilitating management of patient care within an automated environment by allowing entry of ad hoc orders in emergency situations.

### BACKGROUND OF THE INVENTION

With the shortage of skilled caregivers and the growing complexity of the healthcare industry, the potential for devastating healthcare errors has increased. Particular risks exist in dispensing of medications in an institutional environment. Mistakes are often made during this process due to the sheer number of constantly changing caregivers, the growing complexity of health care, and opportunities for error. In a hospital environment, post-surgical procedures can be the most dangerous segment of a patient's hospital stay. A large percentage of medication errors occur in administration of medication due to mistaken patient identification, incorrect medication, or incorrect dosage. Misreading of decimal values for a prescribed dosage is far too common of a phenomenon.

Risks are further increased by errors in specimen testing and collection. Increased nursing workloads can lead to cumulative delays in labeling of specimens. The delays frequently result in inaccurate documentation.

Generally, caregivers are required to read, process and enter patient information in order to administer medications and other treatments. Caregivers such as nurses look at a set of instructions. The caregivers proceed to gather information by interpreting orders entered in a computer. The caregivers perform ordered procedures and create records of the procedures. Furthermore, the caregivers generally interpret an order for each patient. Each order contains a set of tasks. While the caregiver may only be performing one task from the order, the caregiver still is required to interpret the entire order. For example, an order may require administration of medication three times a day for three weeks. A task is performed each time medication is administered. To determine if a task should be performed, the caregiver must check the frequency and duration of the order to determine if action is required. These procedures involve an excessive number of steps and increase the potential for error.

Systems have been developed for managing medication administration, but suffer from various deficiencies. U.S. Patent Publication U.S. 2002/0038392 to De La Huerga discloses a method and apparatus for controlling IV delivery and monitoring. The apparatus includes a patient device for storing patient information and a caregiver device for storing caregiver information. The caregiver uses the caregiver device to read the patient identifier to determine if a delivered medication is appropriate.

The system is not centrally managed and is not task-based since it requires caregivers to interpret orders. This system does not allow for real time updating of patient information for multiple patients simultaneously. The system further does not provide real-time order changes to caregivers and does not allow entry of impromptu orders by authorized caregivers. This deficiency can cause difficulties in emergency situations.

A solution is needed for managing healthcare that is both safe and efficient. The processes and components of the solution should drive care activities that are safe, consistent with a plan of care, properly documented and recorded, and protected from failure of primary systems at all times. The solution should further decrease the efforts and steps required of caregivers in order to minimize the opportunity for error. Additionally, the solution should ensure that caregivers are able to provide necessary patient care in emergency situations.

### BRIEF SUMMARY OF THE INVENTION

In one aspect, the present invention is directed to a system for managing patient care. The system includes a portable computing device having an identifier recognition mechanism, a patient machine-readable identifier, and a patient task list for an identified patient, wherein the task list becomes automatically available upon recognition of the patient machine readable identifier. The system additionally includes recognition tools for determining if an entered task is a recognized task that is consistent with any task contained within the patient task list and a user interface mechanism provided by the portable computing device for allowing an authorized caregiver to enter a new order and perform an unrecognized task.

In an additional aspect, the invention includes a method for managing patient care. The method includes recognizing a patient machine-readable identifier, matching the patient machine-readable identifier with a patient task list, and determining whether an entered task request is consistent with any task on the patient task list. The method additionally includes allowing entry of an order including an unrecognized task by an authorized caregiver.

In yet an additional aspect of the invention, a method is provided for facilitating performance of a patient-related task using a caregiver portable computing device for recognizing a patient identifier and associating a recognized patient with a task list. The method includes implementing automated recognition tools available through the caregiver portable computing device to identify a proposed task and determine if the proposed task is included on the task list. The method additionally includes allowing entry of an order including the proposed task by an authorized caregiver using the caregiver portable computing device if the proposed task is not included on the task list.

### BRIEF DESCRIPTION OF THE DRAWINGS

The present invention is described in detail below with reference to the attached drawings figures, wherein:

FIG. 1 is a block diagram illustrating components of a system for managing patient care in accordance with an embodiment of the invention;

FIG. 2 is a block diagram illustrating components of a system for managing patient care in accordance with an alternative embodiment of the invention;

FIG. 3 is a block diagram illustrating components of a central information system in accordance with an embodiment of the invention;

FIG. 4 is a block diagram illustrating a central database of the central information system in accordance with an embodiment of the invention;

FIG. 5 is a block diagram illustrating a caregiver portable computing device in accordance with an embodiment of the invention;

FIG. 6 is a diagram illustrating an identification device in accordance with an embodiment of the invention;

FIG. 7 is a block diagram illustrating a device link micro-server in accordance with an embodiment of the invention;

FIG. 8 is a flow chart illustrating a method for using the system to process a request in accordance with an embodiment of the invention;

FIG. 9 is a flow chart showing steps for entering an ad hoc request in accordance with an embodiment of the invention; and

FIGS. 10-23 illustrate screen displays of the caregiver portable computing device in accordance with an embodiment of the invention.

### DETAILED DESCRIPTION OF THE INVENTION

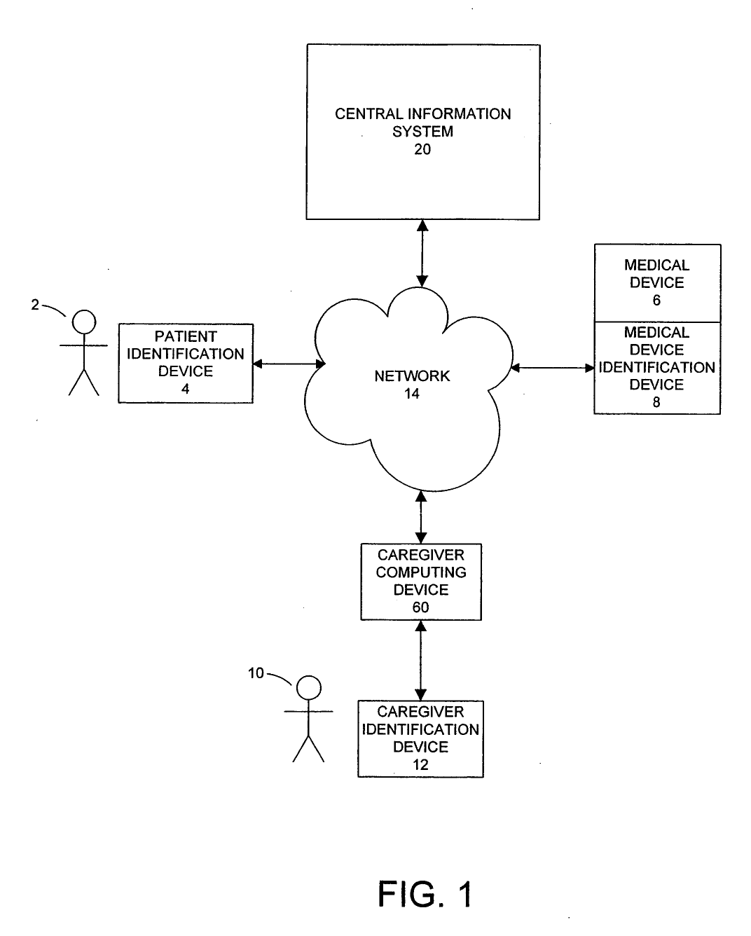

Embodiments of the present invention are directed to a system and method for managing patient care to minimize caregiver error and maximize efficiency. Having briefly provided an overview of the present invention, embodiments of the invention will be discussed with reference to FIGS. 1-23.

Specifically, with initial reference to FIG. 1, a patient identification device 4 may identify a patient 2 and a medical device or medication device identification device 6 may identify a medical device or medication 8. A caregiver identification device 12 may identify a caregiver 10. A central information system 20 and a caregiver portable computing device 60 are capable of communicating over a network 14. The caregiver portable computing device 60 is also capable of processing information from the patient identification device 4, the medical device identification device 8, and the caregiver identification device 12. The caregiver portable computing device 60 can transmit the information to the central information system 20. In this manner, each caregiver 10, each patient 2, and each medication or medical device 6 can be verified with the central information system 20. Although all components are shown as communicating over the network 14, peer-to-peer communication may also be possible. Each of the components of the system is described in greater detail below.

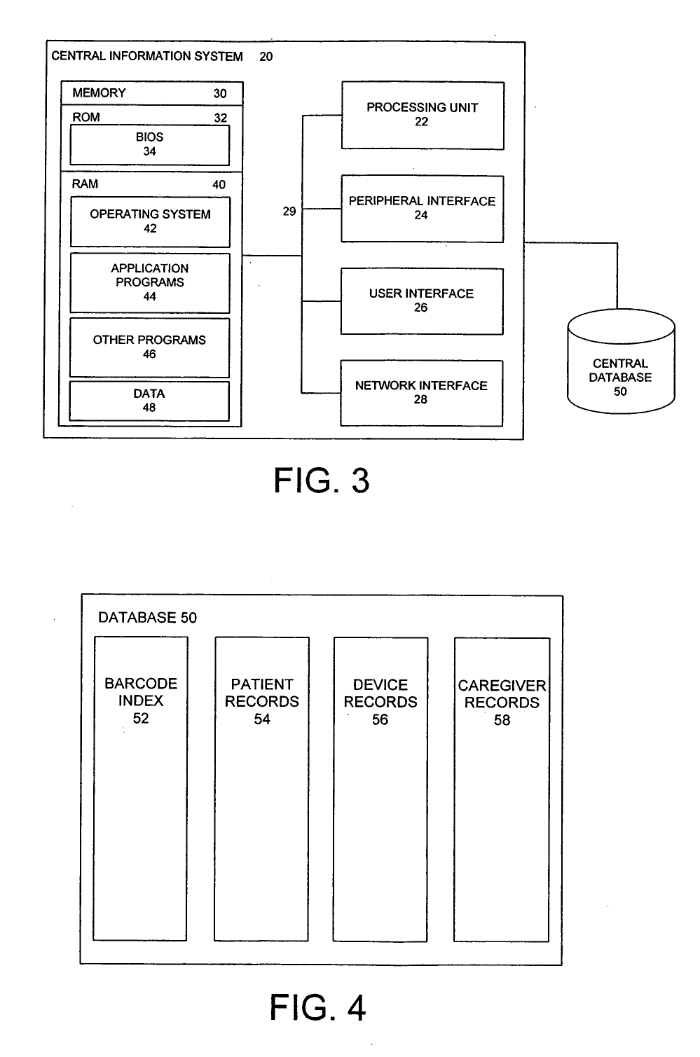

FIG. 3 illustrates an embodiment of the central information system 20. The central information system 20 may include a processing unit 22, a peripheral interface 24, a user interface 26, and a network interface 28. The central information system 20 may also include a memory 30. A system bus 29 couples the aforementioned components. The central information system 20 may also include a central database 50.

The system memory 30 may include computer storage media in the form of volatile and/or nonvolatile memory such as read only memory (ROM) 32 and random access memory (RAM) 40. A basic input/output system 34 (BIOS), containing the basic routines that help to transfer information between elements within the central information system 20, such as during start-up, is typically stored in ROM 32. RAM 40 typically contains data and/or program modules that are immediately accessible to and/or presently being operated on by processing unit 22.

By way of example, and not limitation, FIG. 3 illustrates operating system 42, application programs 44, other program modules 46, and program data 48. The application programs 44 and other programs 46 may be described in the general context of computer-executable instructions, such as program modules, being executed by a computer. The applications programs 44 include components for matching patient data, caregiver data, and medication data in the central database 50 with identifiers transmitted by the caregiver portable computing device 60. Furthermore, the application programs 44 include components for generating a patient task list. The task lists are based upon knowledge databases in the central information system 20 that dictate a particular course of care. These task lists may be contained within the patient records 54 and the caregiver records 58 that are described below with reference to FIG. 4. Generally, program modules include routines, programs, objects, components, data structures, etc. that perform particular tasks or implement particular abstract data types. Moreover, those skilled in the art will appreciate that the invention may be practiced with other computer system configurations, including hand-held devices, multiprocessor systems, microprocessor-based or programmable consumer electronics, minicomputers, mainframe computers, and the like.

The central information system 20 may also include other removable/non-removable, volatile/nonvolatile computer storage media. A hard disk drive may be provided that reads from or writes to non-removable, nonvolatile magnetic media, a magnetic disk drive that reads from or writes to a removable, nonvolatile magnetic disk, and an optical disk drive that reads from or writes to a removable, nonvolatile optical disk such as a CD ROM or other optical media. Other removable/non-removable, volatile/nonvolatile computer storage media that can be used in the exemplary operating environment include, but are not limited to, magnetic tape cassettes, flash memory cards, digital versatile disks, digital video tape, solid state RAM, solid state ROM, and the like. The hard disk drive is typically connected to the system bus through a non-removable memory interface and magnetic disk drive and optical disk drive are typically connected to the system bus by a removable memory interface.

A user may enter commands and information into the central information system through the user interface 26 using input devices such as a keyboard and pointing device, commonly referred to as a mouse, trackball or touch pad. Other input devices may include a microphone, satellite dish, scanner, or the like. These and other input devices are often connected to the processing unit 22 through a user input interface 26 that is coupled to the system bus 29, but may be connected by other interface and bus structures, such as a parallel port or a universal serial bus (USB). A monitor or other type of display device may also be connected to the system bus 29 via an interface, such as the peripheral interface 24. In addition to the monitor, computers may also include other peripheral output devices such as speakers and printer.

The illustrated central information system 20 is merely an example of a suitable environment for the system of the invention and is not intended to suggest any limitation as to the scope of use or functionality of the invention. Neither should the central information system 20 be interpreted as having any dependency or requirement relating to any one or combination of components illustrated.

The central information system 20 in the present invention will operate in a networked environment in conjunction with the network 14 as illustrated in FIG. 1, using logical connections to one or more remote computers, such as the caregiver portable computing device 60. As further described below, the caregiver portable computing device 60 may be a personal computer, and typically includes many of the elements described above relative to the central information system 20.

The network 14 may be the Internet and all components of the system may be accessible over the Internet. Logical connections for networking may include a local area network (LAN) or a wide area network (WAN), but may also include other networks. When used in a LAN networking environment, the central information system 20 may be connected to the LAN through the network interface 28 or adapter. When used in a WAN networking environment, the central information system 20 typically includes a modem or other means for establishing communications, such as the Internet. The modem, which may be internal or external, may be connected to the system bus 29 via the user input interface 26, or other appropriate mechanism.

FIG. 4 illustrates an embodiment of the central database 50 that is a component connected with the central information system 20. The central database 50 may include an identifier index 52 linking the identifiers to the identified patients, devices, medications, and caregivers. In the illustrated embodiment, the identifiers are barcodes and the identifier index 52 is a barcode index. However, the identifiers may include an RF identifier (RFID) or any machine readable identifier. Additionally, the central database 50 may include patient records 54, device records 56, and caregiver records 58. The patient records 54 preferably include each patient's treatment history and orders entered by a physician for treatment of each patient. The device records 56 preferably include device settings and capabilities. The caregiver records 58 preferably include records of assigned tasks for each caregiver in the system. The orders and other information can be accessed through the caregiver portable computing device 60 to determine appropriate tasks to be performed on an identified patient.

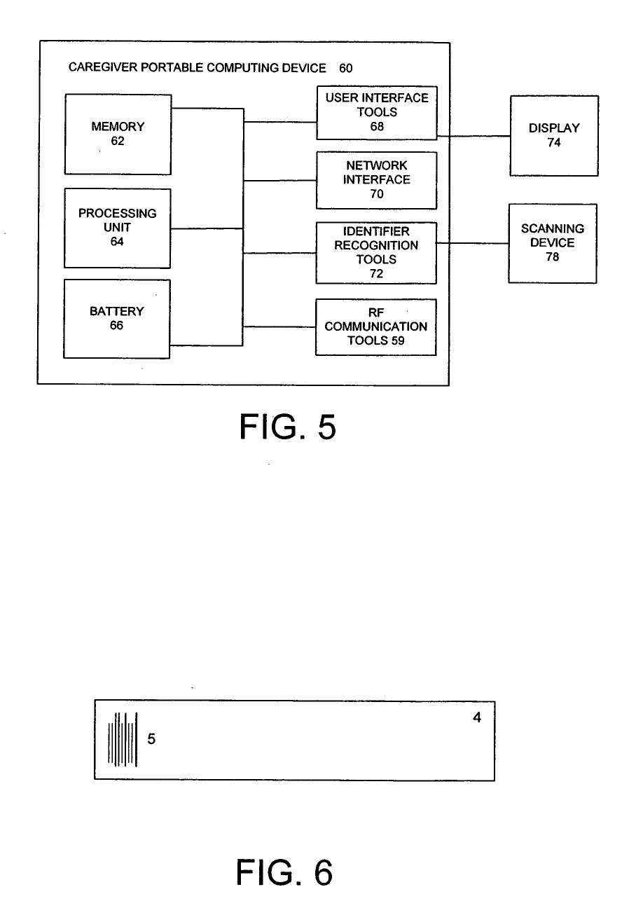

FIG. 5 illustrates an exemplary embodiment of the caregiver portable computing device 60. The caregiver portable computing device 60 may include a memory 62, a processing unit 64, a battery 66, user interface tools 68, network interface 70, RF communication tools 59, and identifier recognition tools 72. The user interface tools 68 may advantageously be accessible through a built-in display device 74. The identifier recognition tools 72 may be connected with a scanning device 78 such as an embedded barcode scanner.

In an embodiment of the invention the caregiver portable computing device 60 is a handheld personal digital assistant (PDA). The PDA puts the power of the central database 50 in the caregiver's hands at the point of care. The PDA recognizes identifiers associated with the patient 2, caregiver 10, devices 6, or procedures. The PDA prompts the caregiver 10 for necessary actions and information during the care-giving process.

The caregiver portable computing device 60 is used as verification device and in an embodiment of the invention is a barcode scanner for the patient identification device and the caregiver identification device. Caregivers may be provided with varying access levels. For instance, a physician may be able to enter tasks, but some less skilled caregivers may not be permitted such a high access level. In this instance, the caregiver portable computing device 60 is capable of verifying access level through the central database 50 and the caregiver identification device 12.

The caregiver portable computing device 60 accesses the central information system 20 through the network interface 70 and prompts caregivers for scheduled tasks, alerts them to potential error, facilitates documentation, and allows caregivers to review data before posting it to central database. Real time updates and current access orders are available through the caregiver portable computing device 60 in real time.

FIG. 6 illustrates an embodiment of the patient identification device 4 including an identifier 5. The identifier 5 is preferably in machine-readable form and may be a scannable barcode or RFID. The patient identification device 4 may be in the form of a patient wristband. The caregiver identification device 12 preferably also includes the identifier 5. The caregiver identification device 12 may be affixed to a caregiver badge in an embodiment of the invention. The medical device and medication identification device 8 preferably also includes a machine-readable identifier as shown. The identifiers associated with the patient, caregiver, and device are preferably all linked to specific data within the central information system database 50.

Every apparatus and medication used in medical treatment of a patient may be labeled with an identifier such as a barcode. Anything that can be tagged with an identifier can be monitored by the system of the invention. For instance, an IV bag coming from the pharmacy including medications can be labeled at the pharmacy with an identifier such as a barcode. In practice, the caregiver would scan the labeled medication before adding it to a pump. The labeled medication may be compared with the patient identifier 5 and tasks on record such as patient dose, timing, and pump setting. Since the pump can also be labeled with an identifier, the system, through the caregiver portable computing device 60 looks for an IV pump to associate with the identified IV bag. The physical infrastructure provides a mechanism for scanning a barcode that is unique to the IV pump. The tubing attached to the pump and IV bag may also receive an identifier. The system then compares dose, timing, and pump setting with orders on record. In this instance, the caregiver portable computing device 60 could provide a green light if all information matches or an alert if a mismatch occurs. In additional to pumps, any of a number of other medical devices that are attached, inserted, laid upon or otherwise physically associated with a patient may be receive an identifier. These devices include a peripheral IV, a central line, a PA catheter, an arterial line, temporary pacemaker wires, epidural catheters, subdural catheters, endotracheal tubes, chest tubes, surgical drains and urinary catheters and implantable devices such as VP shunts, tracheostomies, cardiac pacemakers, medication pumps, implanted central lines, dialysis shunts and vascular filters. Thus, the attachment type may be identified by the physical connection or the medical device associated with connection. Likewise, the products associated with these devices may also be identified, and may be used similarly to the pump-IV medication combinations described herein.

The contents of manually administered medications may also be labeled with a bar code, RFID, or other machine readable identifier. Labeling reduces the possibility of a patient receiving incorrect medication or receiving medication at inappropriate intervals or in inappropriate dosages. Collected specimens may also be labeled with identifiers. With the addition of a mobile printer (not shown), specimens can be labeled at the moment of collection, thus further reducing opportunities for error.

Labeling each component with an identifier provides a physical structure to make IV pumps and other medical devices part of the care environment and part of the workflow. If more than one medication, IV bag, or pump is present, the system is capable of distinguishing them from one another because of the aforementioned identifiers.

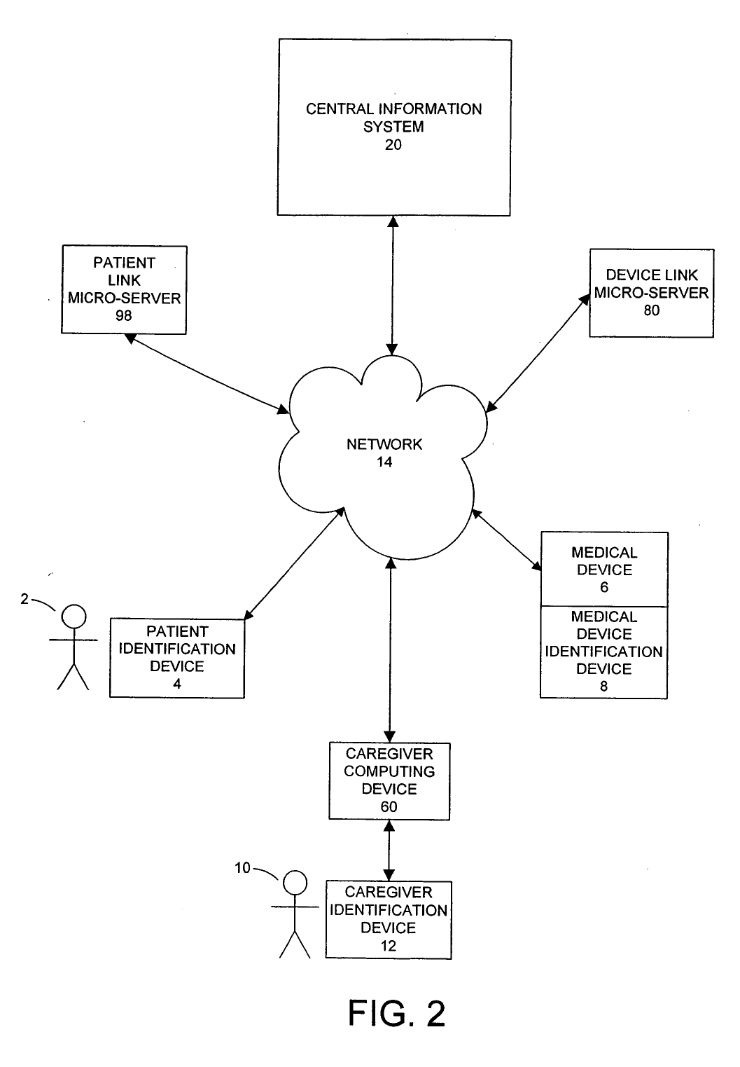

In a second embodiment of the system of the invention as shown in FIG. 2, additional components may be included such as a device link micro-server 80 and a patient link micro-server 98. In implementing the system of the invention, these micro-server components 98 and 80 may both be included or either component 98 or 80 may selectively be implemented.

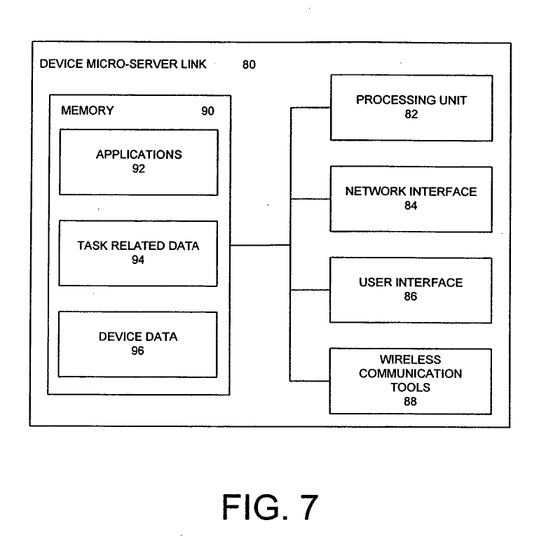

FIG. 7 illustrates an embodiment of the device link micro-server 80. The device link micro-server 80 may include a processing unit 82, a network interface 84, a user interface 86, and wireless or wired communication tools 88. The device link micro-server 80 may also include a memory 90 including applications 92, task related data 94, and device data 96. The device link micro-server 80 has a device driver within its applications 92 and is capable of determining an appropriate communication protocol for the attached device. The device link micro-server 80 uses standard language protocols to communicate with any device and then converts that information to an appropriate format for user by central information system 20. Although all components are shown as communicating over the network 14, peer-to-peer communication may also be possible.

The patient link micro-server 98 may be substantially identical in structure to the device link micro-server 80 and performs a similar function. However, the application programs running on the two devices may differ. The patient link micro-server 98 and the device link micro-server 80 provide caching or local storage of data. The infrastructure of the micro-server devices 80 and 98 allows retention of data and management at nursing unit level. Although the system can function without the micro-servers 80 and 98 as exemplified by FIG. 1, it is desirable to provide an offline data store. Data in the micro-servers 80 and 98 may be stored as tagged extensible mark-up language (XML) data.

Both the patient link micro-server 98 and the device link micro-server 80 are capable of functioning as web servers. The patient link micro-server 98 may function as a web server that caches patient authentication and demographic information for a single associated patient, task data generated from physician orders, and limited clinical result information. Through the wireless or wired communication tools 88, the patient link micro-server 98 communicates with the caregiver portable computing device 60 and the central information system 20 as shown in FIG. 2. The patient link micro-server 98 preferably communicates with the central database 50 via XML but may also support Health Level Seven (HL7) standard protocol and could be configured to operate using the Cerner Millenniums architecture of Cerner Corporation of Kansas City, Mo., or in any appropriate manner in the context of the provided central information system 20.

Each patient may be provided with the patient link micro-server 98. The micro-server 98 may be wireless or hardwired or both to both the central information system 20 and/or the caregiver portable computing device 60, but may record and transmit information about one particular patient. The patient link micro-server 98 stores a snapshot of all information about the associated patient, thus providing back up in case information in the central database 50 becomes inaccessible. The patient link micro-server 98 is capable of functioning as a link between the central database 50 and everything that happens to the patient 2.

Accordingly, the patient link micro-server 98 provides a local, real time, and redundant secondary data store that are specific to the patient. The patient link micro-server 98 is preferably located in the patient room and is connected to the central information system 20 through either a wireless are hardwired connection. The patient link micro-server 98 receives continuous updates to patient-specific information including patient demographics, results, and planned care activities. The data store is temporary, functions during a single episode of care, and may be automatically flushed of data upon discharge of the patient. Thus, the patient link micro-server 98 and the device link micro-server 80 function as localized web servers with information that the caregiver 10 can query.

The caregiver portable computing device 60 with the embedded barcode scanner or other identifier recognition mechanism is preferably capable of communication with the device link micro-server 80 and the patient link micro-server 98 with an RF signal. As discussed above, the patient link micro-server 98 is located in the patient environment and preferably holds the local data store that may be wired to a local network but may also communicate to other components via RF signal. The device link micro-server 80 is attached directly to any patient-attached devices and may communicate to other components via RF signal. Both devices can communicate over the network 14 with the central information system 20 that supplies primary patient-specific information to the patient link micro-server device 98 while the central information system 20 is available.

Both the patient link micro-server 98 and the device link micro-server 80 may continually cache patient specific data from the caregiver portable computing device 60 and any connected medical devices. The cache of information from the micro-servers 80 and 98 may be available from any authorized web browser. The micro-servers 80 and 98 may be directly accessible via a browser over a wired network or using a direct RF network link to the patient link micro-server embedded RF node or the device link micro-server RF node. For access outside the institutional firewall, the micro-servers 80 and 98 may support appropriate encryption schemes. Accordingly, the system continues to support and record care activities even during database downtime because access to the data cached in the micro-servers 80 and 98 is available via a web browser independent of the primary information system is still available.

The micro-servers 80 and 98 are capable of functioning continuously during downtime of the central information system 20 and have the ability to automatically re-synchronize with the central information system 20 when it becomes available. The patient link micro-server 98 receives updates from the central information system 20 based on design criteria and sends updates to the central information system 20 regarding patient activity and acquired device data. Further, the patient link micro-server 98 stores a record of activity performed at the bedside and any data provided to it by adjacent device link micro-servers 80. In the absence of the central information system 20, the patient link micro-server 98 will continue to check activities against its most current activity list and will queue activity updates and data until the central information system 20 signals its availability to accept those updates.

Additionally, as briefly mentioned above, the patient link micro-server 98 may be designed to communicate directly with multiple, bedside patient-attached devices through the device link micro-server 80. In embodiments of the invention, the patient link micro-server 98 is capable of communicating with up to eight device link micro-servers 80.

Data streaming from patient-attached devices is stored continuously in the patient link micro-servers 98 for access by the caregiver 10. The device link micro-server 80 inherits and supports the full range of commands and functions provided by the device manufacturer for each device attached and operates in conjunction with the patient link micro-server 98 to manage the device 6.

The caregiver portable computing device 60 can be used to configure the patient link micro-server 98. In use, the caregiver portable computing device 60 scans the patient identifier 5, an identifier associated with the patient link micro-server 98, and an identifier associated with the device link micro-server 80. This action initiates a routine in the patient link micro-server 98 that initiates a request to the central information system 20 for all patient-specific demographics, results, and activity data for temporary storage in the application server. Devices attached to the device link micro-server 80 become associated to the patient by virtue of their association with the patient-specific patient link micro-server 98.

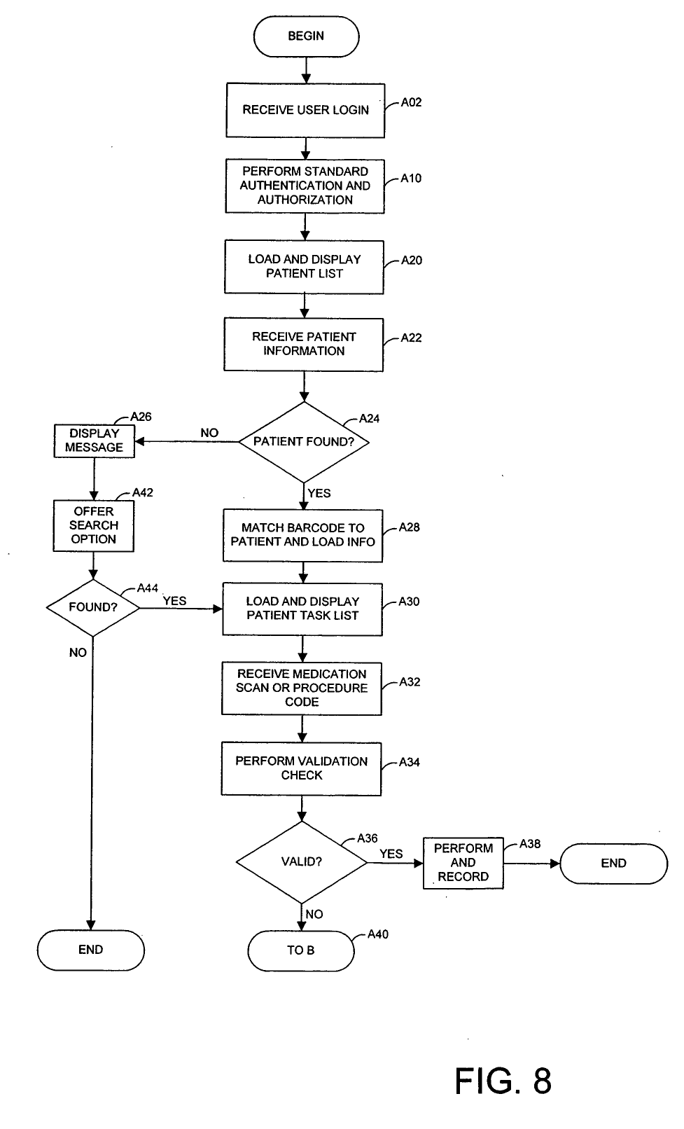

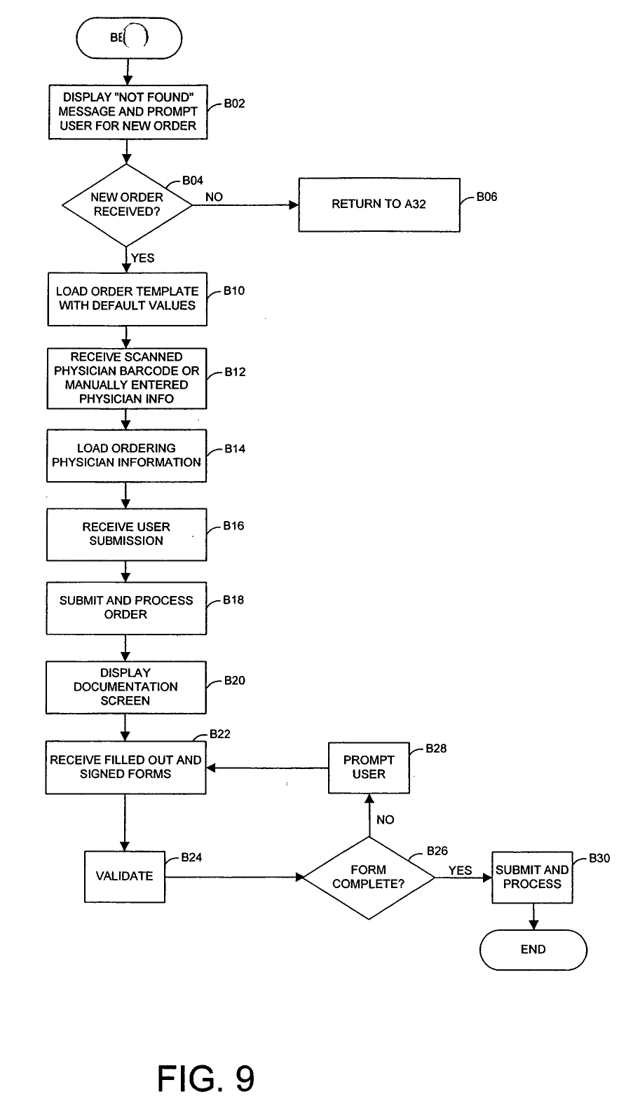

FIGS. 8 and 9 illustrate an embodiment of a method for using the system described above with reference to FIGS. 1-7. In particular, FIGS. 8 and 9 illustrate an embodiment in which a caregiver attempts to perform a task that is not recognized by the automated system. This scenario may be particularly important in emergency situations.

In order to implement the procedures of FIGS. 8 and 9, the caregiver must have access to patient information for the particular subject patient. Additionally, the caregiver must be authorized to place new orders. Finally, the caregiver must have system permission to view lists of tasks authorized for the subject patient.

The description of FIGS. 8 and 9 differ depending upon whether the embodiment of FIG. 1 or FIG. 2 is implemented. FIGS. 8 and 9 are therefore described below in relation to each of the two systems separately.

With regard to FIG. 8, using the system of FIG. 1, in step A02, the system receives a caregiver login from the caregiver via the portable computing device. The login may occur when the caregiver enters the caregiver machine readable identifier on the portable computing device by scanning or otherwise capturing the machine-readable caregiver identifier.

In step A10, upon receiving login information, the system may perform standard authentication procedures for authenticating the caregiver. For instance, the portable computing device will seek verification of the caregiver identity from the central information system. The central information may search its database for the requested information.

Upon verification of the caregiver identity in step A10, the portable computing device may load and display the patient list for the identified caregiver in step A20. The portable computing device may receive the patient list for the identified caregiver from the central information system.

When the caregiver views the patient list, the caregiver enters the patient's identifier into the system, preferably by capturing an identifier on the patient's wristband to identify the patient. The caregiver portable computing device receives the patient identifying information in step A22 and determines in step A24 if the patient is found in the system by communicating with the central information system. If the patient is not found in the system, the caregiver portable computing device displays an appropriate message, such as “Patient not Found”, in step A26.

In step A42, the central information system may offer a search option if the patient is not found. If the patient is found in step A44 after implementing the search option, then the flow returns to step A30 in order to produce the patient task list.

If the patient is located in the central information system in step A24, the system matches the patient identifier with the patient in step A28. The caregiver portable computing device obtains the patient task list from the central information system and loads and displays the patient task list on the portable computing device in step A30. Upon receiving the patient task list in step A30, the caregiver may select a task from the list, enter a procedure code, or scan a medication. In step A32, the caregiver portable computing device receives the selection from the caregiver.

In step A34, the system performs a validation check on the received task information. If the selected task is contained within the patient task list, the system deems the task to be valid such that the task may be performed and recorded in step A38.

In some instances, the selected task may not be found on the patient task list. This inconsistency could be the result of an original omission or an emergency situation in which unforeseen procedures become necessary. In the latter case, it is especially important that an authorized caregiver have the ability to perform and record the necessary emergency procedure. FIG. 9 shows the steps that occur when the desired task has not been ordered and may be necessary in an emergency situation.

FIG. 9 shows the steps performed by the system when the selected task is not found in the patient task list and is evaluated as invalid in step A36. If the task is deemed invalid in step A36, the system will display an appropriate message in step B02 to prompt the caregiver to determine if the caregiver would like to perform this task even though it has not been authorized. If the caregiver would like to perform the task and elects to enter a new order in step B04, the system loads an order template with default values to be displayed on the caregiver portable computing device in step B10.

In step B12, the caregiver portable computing device receives the physician identifier and loads the ordering physician information in step B14. The physician information may be received through the scanning of a patient barcode or through a provider selection conversation with the user interface. The physician fills out any additional necessary information, which is received by the system in step B16. The central information system processes the order in step B18 and displays a documentation screen on the caregiver portable computing device in step B20.

The physician fills out the form on the documentation screen, signs it, and sends the forms to the system through the caregiver portable computing device in step B22. In step B24, the central information system evaluates the form for completeness. If the form is not complete in step B26, the central information system will prompt the user for more information in step B28. If the form is complete in step B26, the central information system will process the documentation such that the new task and order are recognized by the system. The order is submitted through the caregiver portable computing device and processed by the central information system in step B30.

The process flow of FIGS. 8 and 9 may also be performed using the embodiment of FIG. 2. In step A02, the system receives a caregiver login from the caregiver via the portable computing device. The login may occur when the caregiver 10 enters the caregiver machine readable identifier on the portable computing device by scanning or otherwise capturing the machine-readable caregiver identifier.

In step A10, upon receiving login information, the system may perform standard authentication procedures for authenticating the caregiver. For instance, the portable computing device will seek verification of the caregiver identity from the patient link micro-server. Upon verification of the caregiver identity in step A10, the portable computing device may load and display the patient list for the identified caregiver in step A20.

When the caregiver views the patient list, the caregiver enters the patient's identifier into the system, preferably by capturing an identifier on the patient's wristband. The caregiver portable computing device receives the patient identifying information in step A22 and determines in step A24 if the patient is found in the system by communicating with the patient link micro-server. If the patient is not found in the system, the caregiver portable computing device displays an appropriate message in step A26.

In step A42, the patient link micro-server may offer a search option if the patient is not found. If the patient is found in step A44 after implementing the search option, then the flow returns to step A30 in order to produce the patient task list.

If the patient is verified in step A24, the system matches the patient identifier with the patient in step A28. The caregiver portable computing device obtains the patient task list from the patient link micro-server and loads and displays the patient task list on the caregiver portable computing device in step A30. Upon receiving the task list in step A30, the caregiver may select a task from the list, enter a procedure code, or scan a medication. In step A32, the caregiver portable computing device receives the selection.

In step A34, the patient link micro-server performs a validation check on the received information. If the task is contained within the patient task list, the system deems the task to be valid such that the task may be performed and recorded in step A38.

In some instances, the task may not be found on the patient task list. This inconsistency could be the result of an original omission or an emergency situation in which unforeseen procedures become necessary. In the latter case, it is especially important that an authorized caregiver have the ability to perform and record the necessary emergency procedure. FIG. 9 shows the steps that occur when the desired task has not been ordered and may be necessary in an emergency situation.

FIG. 9 shows the steps performed by the system when the entered task is not found in the patient task list and is evaluated as invalid in step A36. If the task is deemed invalid in step A36, the system will display an appropriate message in step B02 and prompt the caregiver to determine if the caregiver would like to perform this task even though the task has not been authorized. If the caregiver wants to perform the task, the caregiver enters a new order in step B04 and the patient link micro-server loads an order template including default values to be displayed on the caregiver portable computing device in step B10.

In step B12, the caregiver portable computing device receives the physician identifier and loads the ordering physician information in step B14. The physician information may be received through the scanning of a patient barcode or through a provider selection conversation with the user interface. The physician fills out any additional necessary information, which is received by the patient link micro-server in step B16. The system processes the order in step B18 and displays a documentation screen on the caregiver portable computing device in step B20.

The physician fills out the form on the documentation screen, signs it, and sends the forms to the patient link micro-server in step B22. In step B24, the patient link micro-server evaluates the form for completeness. If the form is not complete in step B26, the system will prompt the user for more information in step B28. If the form is complete in step B26, the system will process the documentation such that the new task or order is recognized by the system. The order is submitted and processed by the system in step B30.

The procedures set forth above are illustrated from a system perspective. Many of the steps described above are invisible to the caregiver In one embodiment of the invention, from a caregiver perspective, the caregiver uses the portable computing device to log on to the system. The caregiver scans a patient barcode and a medication or procedure barcode. When the system indicates to the caregiver in step A36 that the medication or procedure is not found and prompts the caregiver for a new order, the caregiver selects “yes” in order to enter a new order. The caregiver scans a physician barcode, receives an order template, and fills out all required fields. The physician signs the form and submits the order.

As a result of the procedures provided in FIGS. 8 and 9, ad hoc orders are updated in the system and the patient's medication profile is also updated. As set forth above, the process flows of FIGS. 8 and 9 include multiple consistency checks to enhance the safety of the system and method of the invention. Consistency checks ensure that the patient, medication, dose, timing, and route are accurately identified. Furthermore, despite the safety checks, the system allows impromptu ad hoc orders to be entered by an authorized physician. Thus, emergency situations can be handled quickly and efficiently.

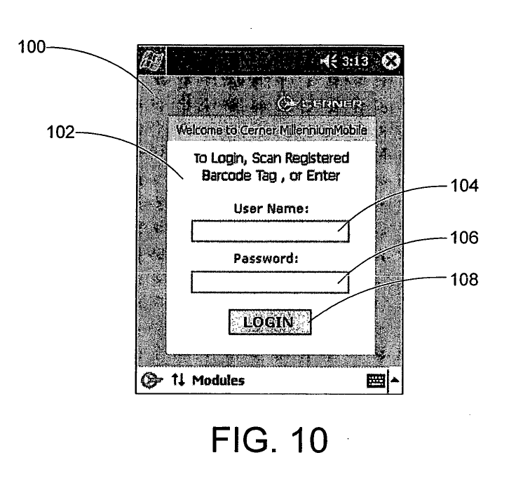

FIGS. 10-23 are screen shots illustrating the user interface that appears on the caregiver portable computing device for the procedures described above with respect to FIGS. 8 and 9.

FIG. 10 illustrates an interface 100 that allows a system user such as a caregiver to log onto the system. An instructional section 102 provides login instructions. The user may scan a barcode tag or enter information manually including user name 104 and password 106. After manually entering this information, the user can actuate the login button 108.

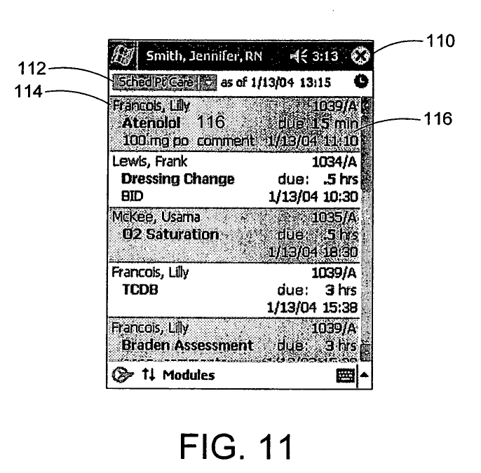

FIG. 11 illustrates a task list that appears on the portable computing device after the caregiver has logged in. The caregiver personal information 110 is followed by a patient care schedule 112. The patient care schedule 112 includes a series of patients 114, each accompanied by task information 116.

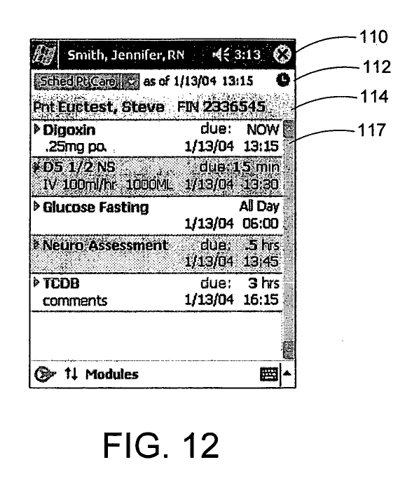

When a caregiver attempts to perform a task for a patient on the list, the caregiver will typically scan a patient barcode. The system attempts to match the barcode scanned to the patient and display a patient task list 117 as shown in FIG. 12. FIG. 12 shows that multiple tasks are scheduled for the patient 114.

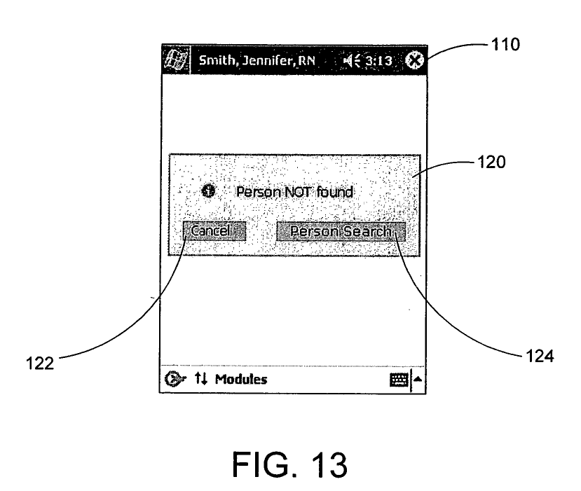

If however, the scanned patient barcode is not matched to a patient, the system displays a message as shown in FIG. 13. In FIG. 13, the caregiver 110 has received a message 120 indicating that the patient is not found. The caregiver 110 can then attempt to find the patient using the “person search” feature 124 or can cancel the attempt using the cancel button 122.

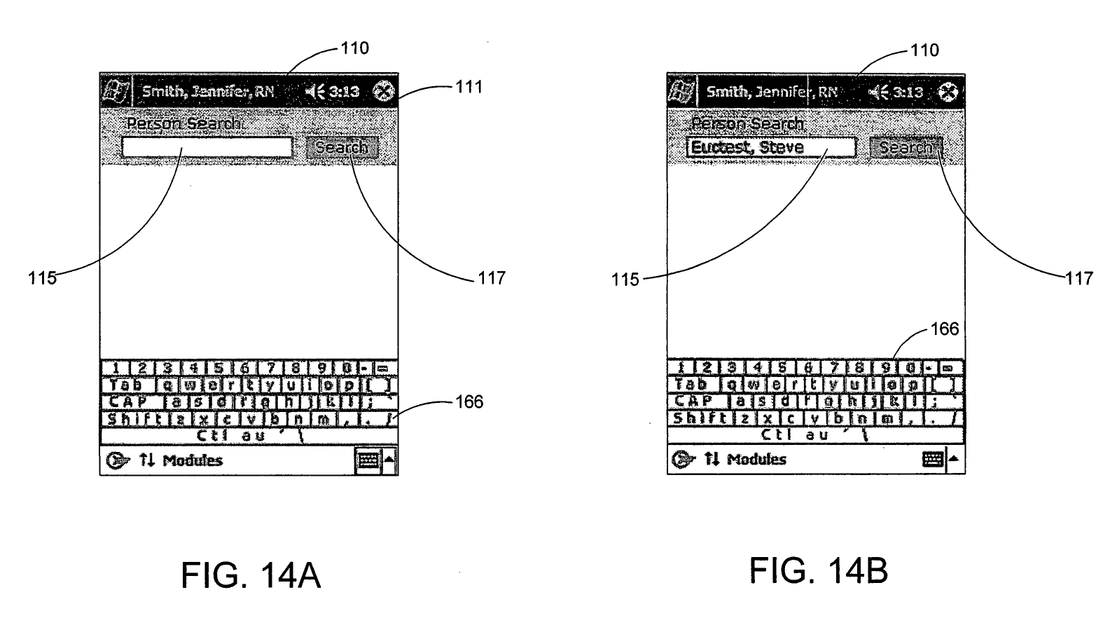

The person search is further illustrated in FIG. 14A. The caregiver 110 can enter a patient's name 115 using a keypad 166. Upon manually entering the name, the caregiver 110 can actuate a search button 117. FIG. 14B illustrates a search for a patient “Euctest, Steve”.

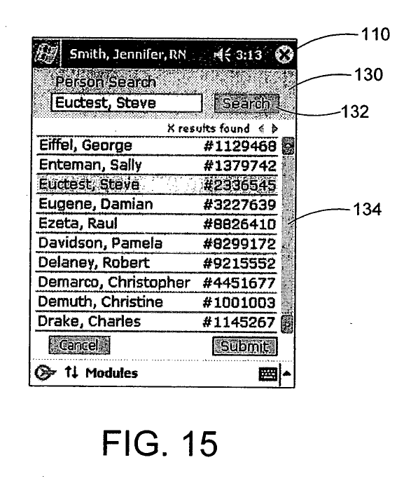

FIG. 15 illustrates the results found by the patient search shown in FIG. 14B. When a list 134 is displayed, if the patient is found in the system, the patient's name is highlighted. The user can then submit the patient name to the system.

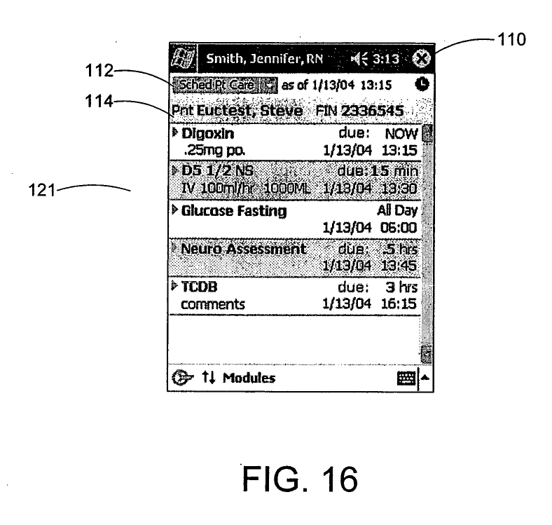

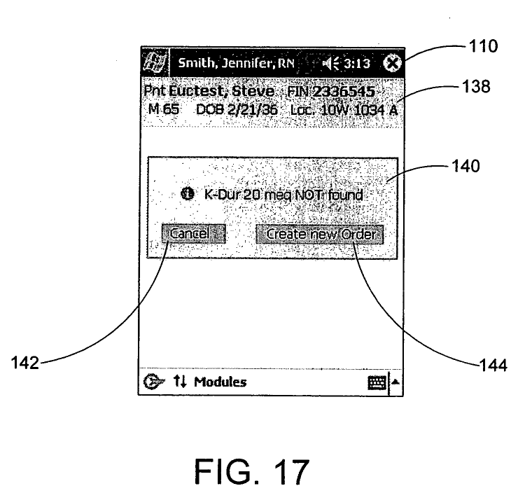

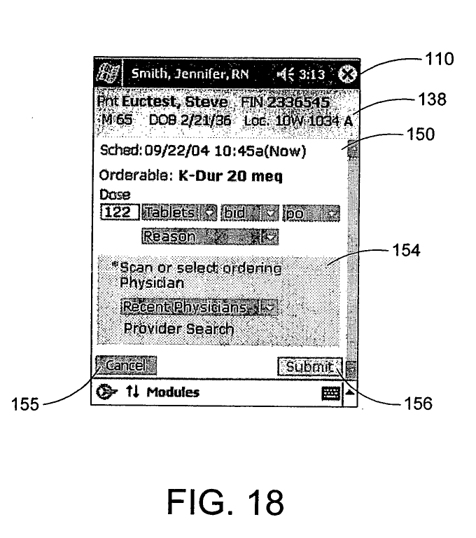

FIG. 16 illustrates a patient specific task list 121 that is found for the patient 114. The caregiver scans an appropriate medication or procedure identifier and the system attempts to validate the medication or procedure against the task list. FIG. 17 illustrates a screen display that appears when the task is not found. A message 140 indicates that the entered task is not found. In response to this message, the user may either actuate a cancel button 142 or create a new order using a button 144.

If the user elects to create a new order, a screen display as shown in FIG. 18 displays ordered task information 150. The order information includes default values from the scanned medication or procedure. The user fills in the necessary information requested in the ordered task information 150 and chooses an ordering provider by scanning or selecting an ordering physician from a provider window 154. Again, the user may either cancel the information using a cancel button 155 or submit the information using a submit button 156.

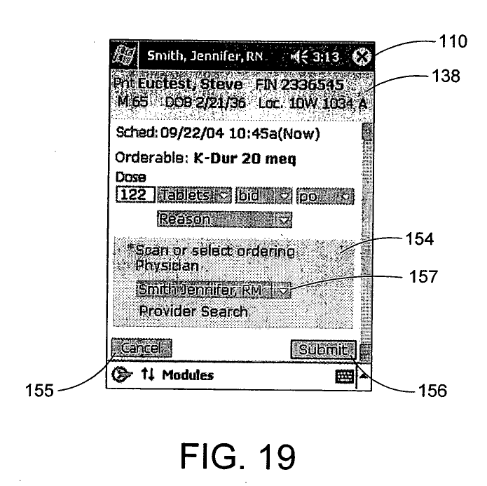

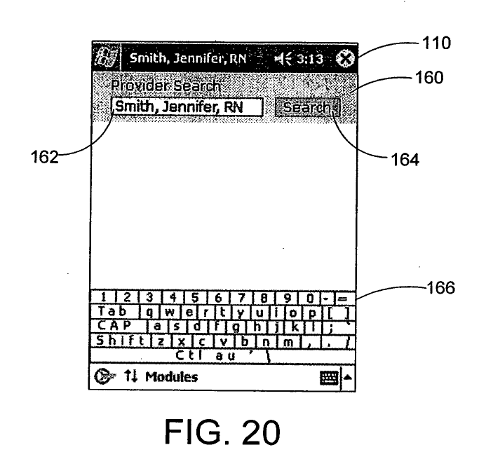

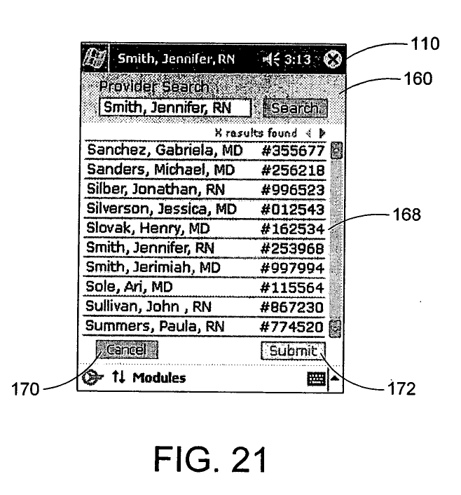

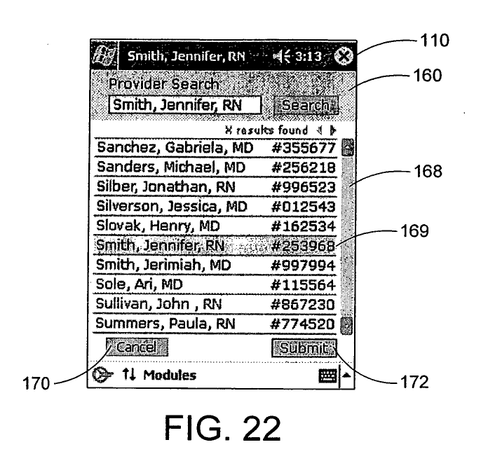

As shown in FIG. 19, scanning the provider barcode allows the system to populate the provider name 157 from the database in the provider window 154. Alternatively, as shown in FIG. 20, the user can enter the provider name 162 by using the keypad 166. The user would then actuate the search button 164 within the provider search window 162. In response, the system displays a list 168 of providers for the user to choose from as shown in FIG. 21. As shown in FIG. 22, when the user has selected the provider, the system highlights the provider name. The user can then submit the name using submit button 172.

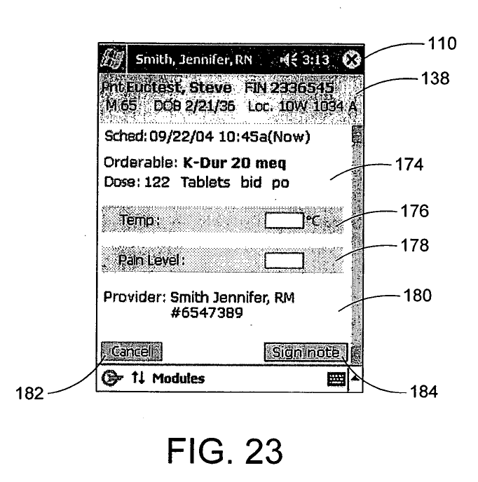

After submission, the system displays a documentation window 174 as shown in FIG. 23. The user completes required documentation including a temperature 176 and a pain level 178. The user then clicks a “sign note” button 184 to submit the documentation to the system.

The system provides an extra measure of protection with its built in data redundancy and downtime access. If the central information system is down due to scheduled maintenance, unscheduled electrical failure, or other event, the local devices such as the device link micro-server 80 and the patient link micro-server 98 save all data since the last connection to central information system 20.

The disclosed system is safer and more efficient than currently used systems because it eliminates unnecessary steps. With the disclosed system, a caregiver can receive directions at a patient's bedside by scanning barcodes or recognizing other machine-readable identifiers. The scanning creates the documentation and eliminates the need for an additional process. Furthermore, since the system uses a central database, last minute change in orders can be captured. A physician can make adjustments and be certain that the caregiver will be alerted in real time. Test results can also be made available as needed and appropriate. The availability of changes to the central information system in real time helps to eliminate errors that occur due to any existing time lag.

While particular embodiments of the invention have been illustrated and described in detail herein, it should be understood that various changes and modifications might be made to the invention without departing from the scope and intent of the invention. For instance, in embodiments of the invention pieces of equipment, supplies and other clinical items known to the information system by an identifier may be scanned and associated with a task. By way of an example, a barcode on a Foley catheter may be scanned, received and validated against a task for insertion of the catheter. The embodiments described herein are intended in all respects to be illustrative rather than restrictive. Alternate embodiments will become apparent to those skilled in the art to which the present invention pertains without departing from its scope.

From the foregoing it will be seen that this invention is one well adapted to attain all the ends and objects set forth above, together with other advantages, which are obvious and inherent to the system and method. It will be understood that certain features and sub-combinations are of utility and may be employed without reference to other features and sub-combinations. This is contemplated and within the scope of the appended claims.

1. A system for managing patient care, the system comprising:
a portable computing device having an identifier recognition mechanism;
a patient machine-readable identifier;
a patient task list for an identified patient, wherein the task list becomes automatically available upon recognition of the patient machine readable identifier;
recognition tools for determining if an entered task is a recognized task that is consistent with any task contained within the patient task list; and
a user interface mechanism provided by the portable computing device for allowing an authorized caregiver to enter a new order including an unrecognized task.

2. The system of claim 1, further comprising a central information system for storing the patient task list.

3. The system of claim 1, further comprising a patient link micro-server for storing the patient task list.

4. The system of claim 1, wherein identifier recognition mechanism includes a scanning device for recognizing and at least one of a machine readable medication identifier and a machine readable procedure identifier.

5. The system of claim 1, wherein the user interface mechanism comprises a warning display for indicating that an unrecognized task is not found.

6. The system of claim 1, wherein the user interface mechanism comprises an order template for new order creation.

7. The system of claim 1, wherein the user interface mechanism includes a provider scanning option and a provider search option for selecting an authorized provider.

8. The system of claim 1, further comprising an order document window for displaying the new order.

9. The system of claim 1, further comprising a patient list that is generated upon caretaker recognition.

10. The system of claim 1, further comprising a warning display for providing an indication of the unrecognized task.

11. A method for managing patient care comprising:
recognizing a patient machine-readable identifier;
matching the patient machine-readable identifier with a patient task list;
determining whether an entered task request is consistent with any task on the patient task list; and
allowing entry of an order including an unrecognized task by an authorized caregiver.

12. The method of claim 11, further comprising obtaining the patient task list from a central information system.

13. The method of claim 11, further comprising obtaining the patient task list from a patient link micro-server.

14. The method of claim 11, further comprising loading and displaying the patient task list on a caregiver portable computing device.

15. The method of claim 11, further comprising receiving a machine readable code from a medication as the entered task request.

16. The method of claim 11, further comprising receiving a machine readable procedure code as the entered task request.

17. The method of claim 11, further comprising displaying a message indicating an unrecognized task on a portable computing device if the proposed task is not included on the patient task list.

18. The method of claim 17, further comprising providing a documentation screen for receiving information for the order.

19. The method of claim 18, further comprising receiving a completed and signed order from a user through the documentation screen.

20. The method of claim 11, further comprising receiving a scanned physician barcode prior to allowing entry of the order.

21. A method for facilitating performance of a patient-related task using a caregiver portable computing device for recognizing a patient identifier and associating a recognized patient with a task list, the method comprising:
implementing automated recognition tools available through the caregiver portable computing device to identify a proposed task and determine if the proposed task is included on the task list; and
allowing entry of an order including the proposed task by an authorized caregiver using the caregiver portable computing device if the proposed task is not included on the task list.

22. The method of claim 21, further comprising receiving a machine readable code from a medication as the proposed task.

23. The method of claim 21, further comprising receiving a machine readable code representing a procedure as the proposed task.

24. The method of claim 21, further comprising obtaining the patient task list from a central information system.

25. The method of claim 21, further comprising obtaining the patient task list from a patient link micro-server.

26. The method of claim 21, further comprising loading and displaying the patient task list on a caregiver portable computing device.

27. The method of claim 21, further comprising displaying a message indicating an unrecognized task on a portable computing device if the proposed task is not included on the patient task list.

28. The method of claim 21, further comprising providing a documentation screen for receiving information for the order.

29. The method of claim 28, further comprising receiving a completed and signed order from a user through the documentation screen.

30. The method of claim 21, further comprising receiving a scanned physician barcode prior to allowing entry of the order.
